(19) United States
(12) Patent Application Publication
(10) Pub. No.: US 2008/0165787 A1
(43) Pub. Date: Jul. 10, 2008

(54) METHOD FOR NEGOTIATING ABOUT THE MEDIA STREAM PACKET TIME LENGTH

(75) Inventors: Peili XU, Shenzhen (CN); Peng WANG, Shenzhen (CN)

Correspondence Address: Leydig, Voit & Mayer, Ltd;(for Huawei Technologies Co., Ltd), Two Prudential Plaza Suite 4900, 180 North Stetson Avenue, Chicago, IL, 60601, US

(73) Assignee: HUAWEI TECHNOLOGIES CO., LTD., Shenzhen (CN)

(21) Appl. No.: 12/050,003

(22) Filed: Mar. 17, 2008

Related U.S. Application Data
(63) Continuation of application No. PCT/CN2006/002394, filed on Sep. 14, 2006.

(30) Foreign Application Priority Data
Sep. 17, 2005 (CN) 200510037373.7

(51) Int. Cl. H04L 12/56

(52) U.S. Cl. 370/395.2

(57) ABSTRACT

A method for negotiating about the media stream packet time length includes: the negotiation initiating party transmits the media stream codec formats supported by itself and the supported packet time length capability information according to each codec format to the negotiation responding party; the negotiation responding party determines the media stream codec formats and the packet time lengths used by the codec formats which are supported by both parties based on the received media stream codec formats and the supported packet time length capability information according to each codec format; the negotiation responding party notifies the determined codec format and the packet time length capability supported by the codec format to the negotiation initiating party in order to finish the negotiation. The invention enables both of the communicating parties to exactly negotiate the packet time length capability supported by each codec capability, thereby it ensures both parties can use the optimum matching packet time length and the communication quality is improved.

### CROSS-REFERENCE TO RELATED APPLICATIONS

This application is a continuation of International Patent Application No. PCT/CN2006/002394, filed Sep. 14, 2006, which claims priority to Chinese Patent Application No. 200510037373.7, filed Sep. 17, 2005, both of which are hereby incorporated by reference.

### FIELD OF THE INVENTION

The present invention relates to the field of multimedia services, and in particular to a method for negotiating media stream packet time in multimedia services.

### BACKGROUND OF THE INVENTION

Today, real-time audio/video multimedia services over Internet Protocol (IP) network are used more and more widely. The real-time media streams in real-time audio/video multimedia services are transmitted mainly through Realtime Transport Protocol (RTP). RTP defines how to construct digitized media streams into message packets for transmission over an IP network. The sender constructs and sends RTP packets at a certain frequency, while the receiver receives and processes RTP packets at a certain frequency. An important parameter in the media stream processing is the packet time of RTP packets. The packet time determines the transmitting frequency of RTP packets. Commonly used media stream packet time values include: 10 ms, 20 ms, and 30 ms. In order to attain an optimal communication, the understanding and processing of media stream packet time must be consistent between the two parties involved in the communication. Therefore, the packet time of media stream is an important parameter in the media capability negotiation process between the two parties involved in the communication.

In existing multimedia communication systems, e.g., (Next Generation Networks (NGNs), IP Multimedia Subsystems (IMSs), etc.), that are based on a signaling protocol such as Session Initiation Protocol (SIP), H.248, or Media Gateway Control Protocol (MGCP), the description of media stream parameters in a media negotiation process is usually implemented through Session Description Protocol (SDP). SDP is a text-based media capability description protocol, which employs syntax like “attrname=parameter . . . ” to describe the capabilities of communication entities. For example:
v=0
o=bill 2890844526 2890842807 IN IP4 126.16.64.4
m=audio 49170 RTP/AVP 0
a=recvonly

in which “v=” represents the version number of SDP, “o=” represents the information of the SDP provider, “m=” represents the information of a media stream, and “a=” is used to provide additional information related to the media stream.

For example, in SIP, a method for negotiating media capabilities (including negotiation of packet time) is defined. A typical process is as follows.

Step 1: The calling SIP user (a@domain.com) initiates a session request by means of an INVITE message to the called user (b@domain.com). The media capabilities of the calling user are carried in the message. The message is as follows:
INVITE sip:b@domain.com SIP/2.0
Via: SIP/2.0/UDP a@domain.com:5061;branch=z9hG4bK74bf9
Max-Forwards: 70
From: a <sip:a@domain.com>;tag=1234567
To: b <sip:b@domain.com>
Call-ID: 12345601@domain
CSeq: 1 INVITE
Contact: <sip: a@domain.com>
Content-Type: application/sdp
Content-Length: . . .
v=0
o=a 2890844526 2890844526 IN IP4 10.0.0.1
s=Session SDP
c=IN IP4 10.0.0.1
t=0 0
m=audio 49170 RTP/AVP 0 4 8
a=ptime:20

in which the information in line “m” indicates that the calling user wants to establish an audio media stream and the codec may be 0 (PCMU), 4 (G.723), and 8 (PCMA); and the information in line “a” indicates that the packet time supported by the called user for the media stream is 20 ms.

Step 2: when the called SIP user (b@domain.com) receives the INVITE message, if he/she wants to accept the call, he/she responds to the calling user (a@domain.com) with a message “200 OK”. The media capabilities of the called user are carried in the message. The message is as follows:
SIP/2.0 200 OK
Via: SIP/2.0/UDP a@domain.com:5061;branch=z9hG4bK74bf9
From: a <sip:a@domain.com>;tag=1234567
To: b <sip:b@domain.com>;tag=137480
Call-ID: 12345601@domain
CSeq: 1 INVITE
Contact: <sip: b@domain.com>
Content-Type: application/sdp
Content-Length: . . .
v=0
o=b 4702834 3847012 IN IP4 10.0.0.2
s=Session SDP
c=IN IP4 10.0.0.2
t=0 0
m=audio 1234 RTP/AVP 4
a=ptime:20

in which the information in line “m” indicates that the called user agrees to establish an audio media stream, and the codec is 4(G.723); and the information in line “a” indicates that the packet time supported by the called user for the media stream is 20 ms.

Step 3: upon receiving the message “200 OK”, the calling SIP user (a@domain.com) sends a message “ACK” to the called user, to confirm the message “200 OK” has been received. The message “ACK” is as follows:
ACK b@domain.com SIP/2.0
Via: SIP/2.0/UDP a@domain.com:5061;branch=z9hG4bK74bf9
From: a <sip:a@domain.com>;tag=1234567
To: b <sip:b@domain.com>;tag=137480
Call-ID: 12345601@domain
CSeq: 1 ACK

Step 4: after above steps, the session establishment and media negotiation processes are accomplished between the calling user and the called user, and each of the calling user and the called user sends media stream information to the communication address of the other according to the media stream codec format and the packet time determined through the negotiation.

In the above media stream capability negotiation process, the two parties carry out the negotiation of the packet time of media stream through the parameter “a=” defined in SDP with a syntax format: a=ptime:<packet time>. This parameter is used to describe the packet time of a corresponding media stream. For example:
m=audio 1234 RTP/AVP 0 4 8
a=ptime: 20

Usually, multiple codec algorithms are available for a media stream in SDP. However, the parameter “ptime” defined above can carry only one value. In the case that multiple codec algorithms are supported for a media stream, the parameter “ptime” can not represent all the packet time capabilities of the codec algorithms, and thereby the packet time can not be negotiated per codec algorithm. In extreme cases, if the packet time processing methods used by the devices for different codec algorithms are incompatible with each other, a communication failure may occur.

In view of the above problem, an SDP extension method is defined in ITU-T V.152, so as to solve the problem partially. The SDP extension method is defined as follows:
a=maxmptime:<list of packet times separated by space>

This parameter is designed to describe the maximum packet time for each codec algorithm corresponding to a media stream. For example:
m=audio 1234 RTP/AVP 0 4 8
a=maxmptime:10 20 30

The principle lies in that multiple values are carried in the extended attribute parameter “maxmptime”, each representing a maximum packet time for a codec algorithm defined at the corresponding location in the media stream.

With the extended SDP, the two parties involved in communication can accomplish negotiation of the maximum packet time capability supported for each codec algorithm.

In the above media stream packet time negotiation process, for each codec algorithm, only the maximum packet time is described, i.e., the devices must support all possible values smaller than the maximum packet time. In practice, however, certain devices may support some of the packet time values. For example, a device may support 30 ms and 20 ms, but does not support 10 ms. Different packet time capabilities supported for each codec algorithm may not be negotiated accurately.

### SUMMARY OF THE INVENTION

The present invention is to provide a method for negotiating media stream packet time, so as to enable the two parties involved in the communication to negotiate accurately the packet time capabilities supported for each codec algorithm, and thereby ensure the two parties can use an optimally matching packet time and improve the quality of the communication.

The present invention provides a method for negotiating media stream packet time including:

sending, from a negotiation initiating party to a negotiation responding party, media stream codec formats supported by the negotiation initiating party and corresponding packet time capabilities supported for each of the media stream codec formats;

determining, at the negotiation responding party, a media stream codec format that can be used locally and a packet time capability used for the media stream codec format, from the media stream codec formats supported by the negotiation initiating party and the corresponding packet time capabilities supported for each of the media stream codec formats; and

sending, from the negotiation responding party to the negotiation initiating party, the stream media codec format that can be used locally and packet time capability used for the media stream codec format, to accomplish the negotiation.

Optionally, the media stream codec formats supported by the negotiation initiating party and the packet time capabilities supported for each of the media stream codec formats have different priorities, and the negotiation responding party selects a media stream codec format with a higher priority and a packet time capability with a higher priority supported for the media stream codec format first.

Optionally, the media stream codec formats supported locally and the packet time capabilities supported for each of the media stream codec formats are carried out by the negotiation initiating party and the negotiation responding party through the session description protocol (SDP).

The media stream codec formats and the packet time capabilities supported for each of the media stream codec formats are described through an extended SDP in the following form:
a=fmtp:<format>ptime=<list of packet timescopes separated by space>

in which <format> represents a media stream codec format; <list of packet timescopes separated by space> represents a list of supported packet times for the media stream codec format.

Optionally, the packet time capabilities supported for a media stream codec format are described through the SDP by listing the packet time capabilities in priority from higher to lower.

Optionally, the media stream codec formats supported by the negotiation initiating party and the packet time capabilities supported for each of the media stream codec formats and the media stream codec format determined by the negotiation responding party and supported by the both parties and the packet time capabilities used for the media stream codec format are described through an extended H.245 protocol before being sent from one party to the other party respectively.

Optionally, the negotiation is carried out through the session initiation protocol (SIP), in which the media stream codec formats supported by the negotiation initiating party and the packet time capabilities supported for each of the media stream codec formats, which are described through the extended SDP, are sent in a SIP INVITE message to the negotiation responding party; and the media stream format determined by the negotiation responding party and supported by the both parties and the packet time capabilities used for the media stream codec format, which are described in the extended SDP, are sent back in a SIP 200 OK message to the negotiation initiating party.

Optionally, the negotiation is carried out through a media gateway control protocol (MGCP), in which the media stream codec formats supported by the negotiation initiating party and the packet time capabilities supported for each of the media stream codec formats, which are described through the extended SDP, are sent in an MGCP CRCX or MDCX message to the negotiation responding party; and the media stream format determined by the negotiation responding party and supported by the both parties and the packet time capabilities used for the media stream codec format, which are described in the extended SDP, are sent back in an MGCP 200 response message to the CRCX or MDCX message to the negotiation initiating party.

Optionally, the negotiation is carried out through a gateway control protocol H.248, in which the media stream codec formats supported by the negotiation initiating party and the packet time capabilities supported for each of the media stream codec formats, which are described through the extended SDP, are sent in a gateway control protocol H.248 ADD or MOD message to the negotiation responding party; and the media stream format determined by the negotiation responding party and supported by the both parties and the packet time capabilities used for the media stream codec format, which are described in the extended SDP, are sent back in a gateway control protocol H.248 response message to the ADD or MOD message to the negotiation initiating party.

Optionally, the negotiation is carried out through a multimedia communication protocol H.323, in which the media stream codec formats supported by the negotiation initiating party and the packet time capabilities supported for each of the media stream codec formats, which are described through the extended H.245 protocol, are sent in an H.245 TerminalCapabilitySet or OpenLogicalChannel message to the negotiation responding party; and the media stream format determined by the negotiation responding party and supported by the both parties and the packet time capabilities used for the media stream codec format, which are described in the extended H.245 protocol, are sent back in an H.245 response message to the TerminalCapabilitySet or OpenLogicalChannel message to the negotiation initiating party.

Compared to the prior art, the present invention has the following benefits.

First, with the method for negotiating media stream packet time according to the present invention, in which the negotiation initiating party sends the optional media stream codec formats supported by itself and the corresponding optional packet time capabilities supported for each of the media stream codec formats to the negotiation responding party; the negotiation responding party determines the media stream codec format supported by the two parties and the packet times used for the media stream codec, from the optional media stream codec formats supported by the negotiation initiating party and the corresponding optional packet time capabilities supported for each of the media stream codec formats; and the negotiation responding party sends the selected media stream codec format and the packet time capabilities used for the media stream codec format to the negotiation initiating party to accomplish the negotiation, the packet time capabilities supported for each media stream codec format may be negotiated accurately.

In addition, in a preferred embodiment of the present invention, different priorities may be set for the media stream codec formats supported by the negotiation initiating party and the packet time capabilities supported for each media stream codec format, and the negotiation responding party may select a media stream codec format with a higher priority and a packet time capability with a higher priority supported for the media stream codec format first, so that the negotiation result may meet an actual demand for media stream transmission better.

### BRIEF DESCRIPTION OF THE DRAWINGS

FIG. 1 is a flow diagram illustrating an embodiment of the method for negotiating media stream packet time according to the present invention, in which SIP is used for the negotiation.

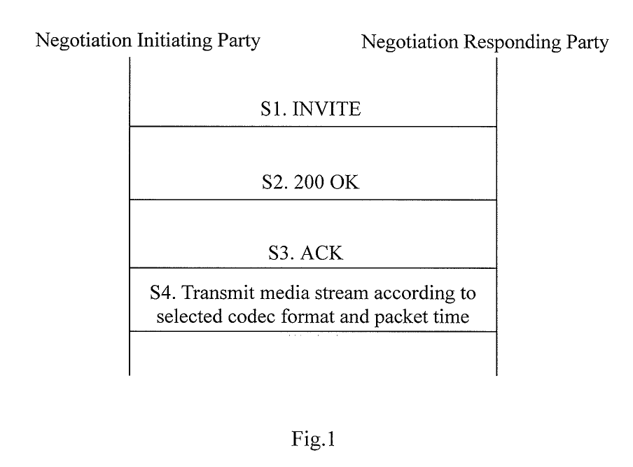

### DETAILED DESCRIPTION OF THE EMBODIMENTS

The present invention supports negotiation of the corresponding packet time capabilities supported for each media stream codec format in a media stream. During the packet time negotiation process, the negotiation initiating party sends the optional media stream codec formats supported by itself and the corresponding optional packet time capabilities supported for each of the media stream codec formats to the negotiation responding party; the negotiation responding party determines the media stream codec format supported by the two parties and the packet times used for the media stream codec, from the optional media stream codec formats supported by the negotiation initiating party and the corresponding optional packet time capabilities supported for each of the media stream codec formats; and the negotiation responding party sends the selected media stream codec format and the packet time capabilities used for the media stream codec format to the negotiation initiating party, so as to accomplish the negotiation of the corresponding packet time capabilities supported for each media stream codec format in the media stream. In actual implementation, the present invention further supports selecting the packet time capabilities supported for each media stream codec format according to priority, i.e., different priorities are set in advance for the media stream codec formats supported by the negotiation initiating part and the packet time capabilities supported for each media stream codec format, and the negotiation responding selects a media stream codec format with a higher priority and a packet time capability with a higher priority supported for the media stream codec format first.

It should be noted that the media stream codec formats supported by the negotiation initiating party and the packet time capabilities supported for each of the media stream codec formats and the media stream codec format determined by the negotiation responding party and supported by the both parties and the packet time capabilities used for the media stream codec format may be described through the extended SDP or other similar protocols (e.g., the H.245 protocol) before being sent from one party to the other party respectively. Hereunder an example in which the media stream packet time capabilities are described through the extended SDP will be explained.

In this example, SDP is extended in the following way to represent the packet times supported for a certain codec algorithm:

codec attribute: codec format; list of optional packet times supported for the codec format. In the SDP, it is defined that:
a=fmtp:<format>ptime=<list of packet timescops separated by space>

in which <format> represents a codec format; <list of packet timescopes separated by space> represents a list of supported packet times for the codec format.

For example:
m=audio 1234 RTP/AVP 0 4
a=fmtp:0 ptime=10 20 30 [symbol] indicating that packet times 10 ms, 20 ms, and 30 ms may be used for format 0 [symbol]
a=fmtp:4 ptime=20 30 [symbol] indicating that packet times 20 ms and 30 ms can be used for format 4. [symbol]
a=fmtp:8 ptime=20 30-40 50 [symbol] indicating that packet times 20 ms, a range of 30-40 ms, and 50 ms can be used for format 8.

[symbol]

The above information described through the extended SDP may further support selection in priority. For example, in the list of packet times, the packet times are listed in priority, enabling packet time negotiation according to priorities.

The present invention may be used in SDP-based multimedia communication systems such as SIP, MGCP, and H.248 to negotiate media stream packet time. Hereunder, an implementation process of negotiation through SIP according to the present invention will be described. The process is as follows.

Step s1: the calling SIP user (a@domain.com) initiates a session request by means of an INVITE message to the called user (b@domain.com). The media capabilities supported by the calling user are carried in the message. The message is as follows:
INVITE sip:b@domain.com SIP/2.0
Via: SIP/2.0/UDP a@domain.com:5061;branch=z9hG4bK74bf9
Max-Forwards: 70
From: a <sip:a@domain.com>;tag=1234567
To: b <sip:b@domain.com>
Call-ID: 12345601@domain
CSeq: 1 INVITE
Contact: <sip: a@domain.com>
Content-Type: application/sdp
Content-Length: . . .
v=0
o=a 2890844526 2890844526 IN IP4 10.0.0.1
s=Session SDP
c=IN IP4 10.0.0.1
t=0 0
m=audio 49170 RTP/AVP 0 4 8
a=fmtp:0 ptime=10 20 30
a=fmtp:4 ptime=20 30
a=fmtp:8 ptime=10 20

in which the information in line “m” indicates that the calling user wants to establish an audio media stream and the codec format may be 0 (PCMU), 4 (G.723), and 8 (PCMA); and the information in line “a” indicates the packet times supported by the called user for each codec format.

Step s2: when the called SIP user (b@domain.com) receives the INVITE message, if he/she wants to accept the call, he/she responds to the called user (b@domain.com) with a message “200 OK”. The media capabilities determined by the called user are carried in the message. The message is as follows:
SIP/2.0 200 OK
Via: SIP/2.0/UDP a@domain.com:5061;branch=z9hG4bK74bf9
From: a <sip:a@domain.com>;tag=1234567
To: b <sip:b@domain.com>;tag=137480
Call-ID: 12345601@domain
CSeq: 1 INVITE
Contact: <sip: b@domain.com>
Content-Type: application/sdp
Content-Length: . . .
v=0
o=b 4702834 3847012 IN IP4 10.0.0.2
s=Session SDP
c=IN IP4 10.0.0.2
t=0 0
m=audio 1234 RTP/AVP 4
a=fmtp:4 ptime=20

in which the information in line “m” indicates that the called user agrees to establish an audio media stream, and the codec format is 4(G.723); and the information in line “a” indicates that the packet time supported by the called user for the media stream is 20 ms.

Step s3: upon receiving the message “200 OK”, the calling SIP user (a@domain.com) sends a message “ACK” to the called user, to confirm that the message “200 OK” has been received. The message “ACK” is as follows:
ACK b@domain.com SIP/2.0
Via: SIP/2.0/UDP a@domain.com:5061;branch=z9hG4bK74bf9
From: a <sip:a@domain.com>;tag=1234567
To: b <sip:b@domain.com>;tag=137480
Call-ID: 12345601@domain
CSeq: 1 ACK

Step s4: after above steps, the session establishment and media negotiation processes are accomplished between the calling user and the called user, and each of the calling user and the called user sends media stream information to the communication address of the other according to the media stream codec format (4) and the packet time (20 ms) determined through the negotiation.

The present invention may further enable the two parties involved in the communication to select an optimal packet time according to priorities. Here, the packet times supported for each codec format may be listed in priority. Each of the two parties involved in the communication may select an optimal packet time according to the priority requirement of the other, with reference to its own capabilities and strategies.

It should be noted that although the above solutions of the present invention are described with reference to an example that the packet time negotiation is carried out through SIP, the present invention also supports negotiation through SDP-based protocols such as MGCP and H.248. For example, if the negotiation is carried out through MGCP, the media stream codec formats supported by the negotiation initiating party and the packet time capabilities supported for each of the media stream codec formats, which are described through the extended SDP, are sent in an MGCP CRCX or MDCX message to the negotiation responding party; and the media stream format determined by the negotiation responding party and supported by the both parties and the packet time capabilities used for the media stream codec format, which are described in the extended SDP, are sent back in an MGCP 200 response message to the CRCX or MDCX message to the negotiation initiating party. If the negotiation is carried out through the gateway control protocol H.248, the media stream codec formats supported by the negotiation initiating party and the packet time capabilities supported for each of the media stream codec formats, which are described through the extended SDP, are sent in a gateway control protocol H.248 ADD or MOD message to the negotiation responding party; and the media stream format determined by the negotiation responding party and supported by the both parties and the packet time capabilities used for the media stream codec format, which are described in the extended SDP, are sent back in a gateway control protocol H.248 response message to the ADD or MOD message to the negotiation initiating party. If the negotiation is carried out through the multimedia communication protocol H.323, the media stream codec formats supported by the negotiation initiating party and the packet time capabilities supported for each of the media stream codec formats, which are described through the extended H.245 protocol, are sent in an H.245 TerminalCapabilitySet or OpenLogicalChannel message to the negotiation responding party; and the media stream format determined by the negotiation responding party and supported by the both parties and the packet time capabilities used for the media stream codec format, which are described in the extended H.245 protocol, are sent back in an H.245 response message to the TerminalCapabilitySet or OpenLogicalChannel message to the negotiation initiating party.

While the present invention has been illustrated and described with reference to some preferred embodiments, the present invention is not limited thereto. Various variations, equivalent substitutions and modifications can be made without departing from the spirit and scope of the present invention as defined by the accompanying claims.

What is claimed is:

1. A method for negotiating media stream packet time, comprising:
receiving, by a negotiation responding party, media stream codec formats supported by a negotiation initiating party and corresponding packet time capabilities supported for each of the media stream codec formats from the negotiation initiating party;
determining, a media stream codec format that can be used by the negotiation responding party and a packet time capability used for the media stream codec format, from the media stream codec formats supported by the negotiation initiating party and the corresponding packet time capabilities supported for each of the media stream codec formats; and
sending the stream media codec format that can be used by the negotiation responding party and packet time capability used for the media stream codec format to the negotiation initiating party, to accomplish the negotiation.

2. The method for negotiating media stream packet time according to claim 1, wherein the media stream codec formats supported by the negotiation initiating party and the packet time capabilities supported for each of the media stream codec formats have different priorities, and the negotiation responding party selects a media stream codec format with a higher priority and a packet time capability with a higher priority supported for the media stream codec format first.

3. The method for negotiating media stream packet time according to claim 1, wherein the media stream codec formats supported by the negotiation initiating party and the negotiation responding party and the packet time capabilities supported for each of the media stream codec formats are carried out through the session description protocol (SDP).

4. The method for negotiating media stream packet time according to claim 3, wherein the media stream codec formats and the packet time capabilities supported for each of the media stream codec formats are described through an extended SDP in the following form:
codec attribute: codec format; list of supported packet times for the codec format.

5. The method for negotiating media stream packet time according to claim 2, wherein the packet time capabilities supported for a media stream codec format are described by listing the packet time capabilities in priority from higher to lower.

6. The method for negotiating media stream packet time according to claim 1, wherein the media stream codec formats supported by the negotiation initiating party, the packet time capabilities supported for each of the media stream codec formats, the media stream codec format determined by the negotiation responding party, and the packet time capabilities used for the media stream codec format are described through an extended H.245 protocol before being sent from one party to the other party respectively.

7. The method for negotiating media stream packet time according to claim 3, wherein the negotiation is carried out through the session initiation protocol (SIP), in which the media stream codec formats supported by the negotiation initiating party and the packet time capabilities supported for each of the media stream codec formats, which are described through the extended SDP, are sent in a SIP INVITE message to the negotiation responding party; and the media stream format determined by the negotiation responding party and supported by the both parties and the packet time capabilities used for the media stream codec format, which are described in the extended SDP, are sent back in a SIP 200 OK message to the negotiation initiating party.

8. The method for negotiating media stream packet time according to claim 3, wherein the negotiation is carried out through a media gateway control protocol (MGCP), in which the media stream codec formats supported by the negotiation initiating party and the packet time capabilities supported for each of the media stream codec formats, which are described through the extended SDP, are sent in an MGCP CRCX or MDCX message to the negotiation responding party; and the media stream format determined by the negotiation responding party and supported by the both parties and the packet time capabilities used for the media stream codec format, which are described in the extended SDP, are sent back in an MGCP 200 response message to the CRCX or MDCX message to the negotiation initiating party.

9. The method for negotiating media stream packet time according to claim 3, wherein the negotiation is carried out through a gateway control protocol H.248, in which the media stream codec formats supported by the negotiation initiating party and the packet time capabilities supported for each of the media stream codec formats, which are described through the extended SDP, are sent in a gateway control protocol H.248 ADD or MOD message to the negotiation responding party; and the media stream format determined by the negotiation responding party and supported by the both parties and the packet time capabilities used for the media stream codec format, which are described in the extended SDP, are sent back in a gateway control protocol H.248 response message to the ADD or MOD message to the negotiation initiating party.

10. The method for negotiating media stream packet time according to claim 3, wherein the negotiation is carried out through a multimedia communication protocol H.323, in which the media stream codec formats supported by the negotiation initiating party and the packet time capabilities supported for each of the media stream codec formats, which are described through the extended H.245 protocol, are sent in an H.245 TerminalCapabilitySet or OpenLogicalChannel message to the negotiation responding party; and the media stream format determined by the negotiation responding party and supported by the both parties and the packet time capabilities used for the media stream codec format, which are described in the extended H.245 protocol, are sent back in an H.245 response message to the TerminalCapabilitySet or OpenLogicalChannel message to the negotiation initiating party.

11. A network device for negotiating media stream packet time, comprising:
means for sending media stream codec formats supported by the network device and corresponding packet time capabilities supported for each of the media stream codec formats to a negotiation responding party;
means for receiving a stream media codec format that can be used by the negotiation responding party and packet time capability used for the media stream codec format from the negotiation responding party, wherein the negotiation responding party determines the media stream codec format that can be used by itself and a packet time capability used for the media stream codec format, from the media stream codec formats supported by the network device and the corresponding packet time capabilities supported for each of the media stream codec formats.

12. The network device of claim 11, wherein the media stream codec formats supported by the network device and the negotiation responding party and the packet time capabilities supported for each of the media stream codec formats are carried out through the session description protocol (SDP).

13. The network device of claim 12, wherein the media stream codec formats and the packet time capabilities supported for each of the media stream codec formats are described through an extended SDP in the following form:
codec attribute: codec format; list of supported packet times for the codec format.

14. A network device for negotiating media stream packet time, comprising:
means for receiving media stream codec formats supported by a negotiation initiating party and corresponding packet time capabilities supported for each of the media stream codec formats from the negotiation initiating party;
means for determining a media stream codec format that can be used by the network device and a packet time capability used for the media stream codec format, from the media stream codec formats supported by the negotiation initiating party and the corresponding packet time capabilities supported for each of the media stream codec formats; and
means for sending the stream media codec format that can be used by the network device and packet time capability used for the media stream codec format to the negotiation initiating party.

15. The network device of claim 14, wherein the media stream codec formats supported by the negotiation initiating party and the packet time capabilities supported for each of the media stream codec formats have different priorities, and the network device further comprises:
means for selecting a media stream codec format with a higher priority and a packet time capability with a higher priority supported for the media stream codec format first.

16. The network device of claim 14, wherein the media stream codec formats supported by the negotiation initiating party and the network device and the packet time capabilities supported for each of the media stream codec formats are carried out through the session description protocol (SDP).

17. The network device of claim 15, wherein the media stream codec formats and the packet time capabilities supported for each of the media stream codec formats are described through an extended SDP in the following form:
codec attribute: codec format; list of supported packet times for the codec format.

18. The network device of claim 14, wherein the packet time capabilities supported for a media stream codec format are described by listing the packet time capabilities in priority from higher to lower.
